(19) United States
(12) Patent Application Publication
(10) Pub. No.: US 2016/0107780 A1
(43) Pub. Date: Apr. 21, 2016

(54) TRAY MEALS WITH HEAT STAKED LIDDING FILM

(71) Applicant: LUVO USA, LLC, Schaumburg, IL (US)

(72) Inventors: Eric A. Carré, Grayslake, IL (US); Robert Shaw, Lisle, IL (US); Anthony Scotti, Schaumburg, IL (US)

(21) Appl. No.: 14/980,040

(22) Filed: Dec. 28, 2015

Related U.S. Application Data
(63) Continuation-in-part of application No. 13/903,690, filed on May 28, 2013, now Pat. No. 9,242,780.
Application No. 13/903,690 is a continuation-in-part of application No. 12/566,209, filed on Sep. 24, 2009, now Pat. No. 9,073,679.
Application No. 12/566,209 is a continuation of application No. 11/703,967, filed on Feb. 8, 2007, now Pat. No. 7,750,274.
Application No. 11/703,967 is a continuation-in-part of application No. 11/351,766, filed on Feb. 10, 2006, now abandoned.

(51) Int. Cl. B65B 63/08; B65B 51/10; A23L 3/36

(52) U.S. Cl. CPC B65B 63/08; A23L 1/48; A23L 3/364; B65B 51/10; A23V 2002/00

(57) ABSTRACT

Frozen food packages and methods of producing and using the same is disclosed. The food package can include a bag or tray which is freezable, ovenable and/or microwaveable. A frozen food assembly within the bag or tray can include uncooked, cooked, or partially cooked food. The food assembly can include a meat, a fruit or vegetable, and a flavoring liquid such as a broth or stock, and may include infused oil or a dairy product. The food can be embedded in the frozen liquid which can facilitate handling and shipping. The method can include sealing the frozen food in the tray using a heat staked lidding film or vacuum wrapping and cooking the food in the tray where steam is generated from the frozen liquid when heated. The resulting dish is a substantial improvement over the well-known precooked frozen meals.

### TECHNICAL FIELD

The present invention relates generally to food bags and trays containing frozen food items that are cooked, partially cooked, or uncooked and may be stored, displayed and cooked in a standard (convection) or microwave oven.

### BACKGROUND

There is a need in the art for frozen meals or other food items which can be displayed in a store and cooked at home. More particularly, there is a need in the art for such frozen foods which are primarily made from fresh, uncooked ingredients. There is also a need for trays with heat staked lidding films in which frozen meals or other food items can be displayed and/or cooked.

### BRIEF SUMMARY OF THE INVENTION

An embodiment of the invention comprises an apparatus comprising a bag which is freezable and at least one of ovenable and microwaveable; and a frozen food assembly which includes cooked, uncooked, or partially cooked food and is disposed within the bag.

Another embodiment of the invention further provides a method comprising the steps of providing frozen cooked, uncooked, or partially cooked food in a bag; sealing the bag (preferably seam side up) so that the bag is impermeable to liquids; and cooking the food in the bag while the bag is sealed.

Another embodiment of the invention comprises method of making a food package comprising a frozen molded food form contained in a sealed tray, said method comprising: providing a tray having a cavity, placing liquid and food in the cavity, placing the tray in a freezer, wherein the liquid and food freeze to form a frozen molded food form in the cavity, and removing the tray from the freezer, wherein the tray is sealed with a heat staked film prior to placing the tray in the freezer or after removing the tray from the freezer.

Another embodiment of the invention comprises method of making a food package comprising a frozen molded food form contained in a sealed tray, said method comprising: providing a tray having a cavity, placing liquid and food in the cavity, placing the tray in a freezer, wherein the liquid and food freeze to form a frozen molded food form in the cavity, and removing the tray from the freezer, wherein the tray is vacuum wrapped prior to placing the tray in the freezer or after removing the tray from the freezer.

### BRIEF DESCRIPTION OF THE SEVERAL VIEWS OF THE DRAWINGS

FIG. 1 is perspective view of the frozen food package of the present invention showing the frozen food items visible through the window of the bag (although the bag can instead be provided as having no window, and instead having a seam running down the middle), according to an exemplary embodiment.

FIG. 2 is a perspective view of the freezing tray in which the food items of the present invention are frozen prior to insertion in the food bag, according to an exemplary embodiment.

FIG. 3 is a perspective view similar to FIG. 2 showing the food items (cooked, partially cooked, or uncooked) having been placed in the tray prior to the freezing thereof, according to an exemplary embodiment.

FIG. 4 is a diagrammatic view showing the tray in a freezer with the food items having been frozen in the freezing tray to produce a frozen molded dish, according to an exemplary embodiment.

FIG. 5 is a diagrammatic view showing the frozen molded dish being inserted into the food bag, according to an exemplary embodiment.

FIG. 6 is a fragmentary side elevational view showing the bag having been heat sealed, according to an exemplary embodiment.

FIG. 6A is a view similar to FIG. 6 showing the bag being additionally sealed by an adhesive, according to an exemplary embodiment.

FIG. 7 is a diagrammatic elevational view of a plurality of the food bags on display in a store freezer section, according to an exemplary embodiment.

FIG. 8 is a diagrammatic side elevational view showing the frozen food package in an oven at an initial stage of cooking, according to an exemplary embodiment.

FIG. 9 is similar to FIG. 8 and shows the food bag having expanded as a result of the cooking process, according to an exemplary embodiment.

FIG. 10 shows the food bag having been opened and the cooked food items being removed therefrom onto a plate, according to an exemplary embodiment.

FIG. 11 is a perspective view of a food tray with a heat staked lidding film, according to an exemplary embodiment.

### DETAILED DESCRIPTION OF THE INVENTION

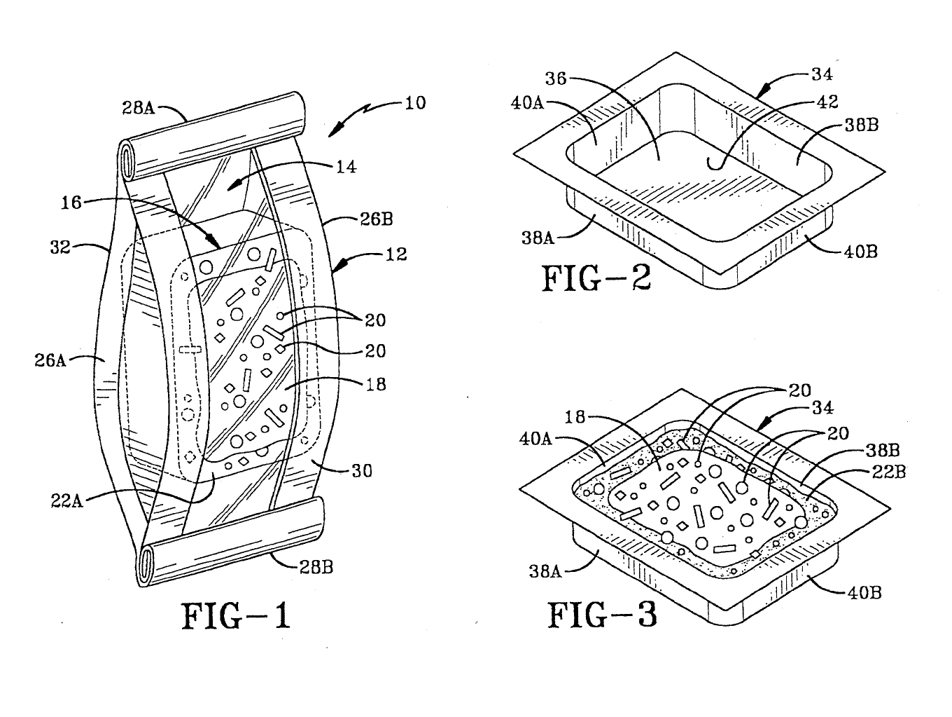

The frozen food package of the present invention is indicated generally at 10 in FIG. 1 and the method of preparing and using the food package is described with reference to FIGS. 2-11. As shown in FIG. 1, food package 10 includes an expandable food bag 12 having a transparent window 14 (although the bag can instead be provided as having no window, and instead having a seam running down the middle) and a frozen food item or assembly 16 which is typically in the form of an entrée. Food assembly 16 is primarily formed of frozen fresh, uncooked, cooked or partially cooked ingredients. Food assembly 16 typically includes a meal-sized source of protein most often in the form of a meat 18 or for instance a bean-based food item. Food assembly 16 typically also includes pieces 20 of vegetables, fruits, spices or the like.

Food assembly 16 typically further includes a frozen liquid 22A which may involve the use of water, oil (preferably an infused oil), water-based liquids such as meat or vegetable-based broths or stocks (e.g. jus, fumet etc.), and milk, cream or other dairy based products. Jus is a prepared natural juice from various types of meat or poultry, and fumet is a light fish stock. Food assembly 16 may be free of pre-made sauces and chemical preservatives, although each of these may be used if desired. Although food assembly 16 is primarily formed of uncooked food, cooked or partially cooked food may be included. The broths, stocks and sauces are all normally formed by cooking, and other cooked elements may also be used if desired.

Liquid 22A may simply be water or a sauce, or may be jus, fumet or another broth or stock with or without further additives, and is typically mostly water. Meat stocks may include some gelatin derived from bones. While liquid 22A is typically free of an added thickening agent such as starch, gums, flour or gelatin, these may be included although usually in relatively small amounts. Liquid 22A is preferably at least 90.0% water by weight or any percentage thereabove up to 100%. These percentages are associated roughly with the amount of soluble solids in meat stocks and flavored broths, which may be determined by a refractometer or determined by measuring the solid remaining upon evaporation of said stocks or broths. For instance, such solids for meat or fish stocks typically ranges from about 4.0 to 8.0% by weight and for flavored broths typically ranges from about 0.25 to 4.0% by weight with the remainder being water.

Various viscosities are given hereafter, all of which are for liquids at 150° F. (65.5° C.), including water with a viscosity of about 0.0 cPs. Flavored broths typically have a viscosity anywhere in the range of about 0.0 to 500 cPs. Meat or fish stocks (jus, fumet) typically have a viscosity anywhere in the range of about 500 to 1000 cPs, this higher viscosity relative to the broths due primarily to the above-noted gelatin from the bones. The viscosity of liquid 22A thus typically falls within these ranges.

Sauces which are part of food assembly 16 typically have a viscosity which is substantially greater than that of liquid 22A although in general very light sauces are similar in viscosity to the more viscous stocks. Sauces have a viscosity anywhere in the range of about 1,000 to 8,000 cPs, the former being very light and the latter being very heavy. A medium viscosity sauce is generally somewhere around 4,000 cPs. Thus, most sauces are somewhere in the range of about 2,000 to 7,000 cPs; usually in the range of 2,000 to 6,000 cPs; and often in the range of 3,000 to 5,000 cPs although these numbers may vary substantially depending on the type of sauce.

Preferably, there is sufficient frozen liquid 22A in order to hold the various items of assembly 16 together as a block or a unit although small pieces of food may be separate from the block or unit. Thus, meat 18 and pieces 20 are usually embedded in frozen liquid 22A, and preferably all or substantially all of the food is embedded therein. The formation of this block or unit is an important aspect in handling and assembly as discussed further below.

In an embodiment, the liquid 22A may be a water or a sauce and may be placed on top of the cooked or partially cooked food, such that it covers at least part of the top surface of the one or more pieces of food. The liquid 22A (which may be water-based or a sauce) may cover the entirety of the food product, such that the food product is not, or substantially is not, visible. The liquid 22A may also surround the food product such that when the food product is frozen, the food product is substantially embedded within the liquid to form a block.

It must be understood that the placement of each component is very critical, each introduced in the center of the tray and moved toward the side to push the liquids toward the side of the tray. When the meal is finalized, and before the freezing step, a ring of liquid is formed around the meal which will vaporize immediately when placed in the microwave or convection oven. This vapor condenses on the surface of the frozen food and creates heat transfer and heat penetration which cooks the meal and precludes the electrons of the microwave, for example, from drying the food.

In one embodiment, the frozen liquid 22A may comprise both a sauce and a water-based liquid. In such an embodiment, the sauce may substantially encircle the base surface, perimeter and top surface of the food product, such that the food product is embedded within the sauce. Additionally, the water-based liquid may surround the sauce-food product unit forming a ring of water-based liquid around the sauce-food product. The water-based liquid may vaporize immediately when placed in the microwave oven. The vaporized water-based liquid may then condense onto the surface of the sauce-food product and aid in cooking the sauce-food product, for example precluding drying of the food product.

In addition, frozen liquid 22A provides distinct advantages during the cooking process described further below. The portion size, or total weight of food assembly 16, may vary and is typically set within a range suitable for a single meal, more or less. In most cases, this would be somewhere in the range of 8.0 to 16.0 ounces although in light of the difference in people's sizes and appetites, such meal sizes are typically somewhere in the range of about 4.0 to 32.0 ounces. While these numbers do not limit the scope of the invention, they give an idea of the portion sizes typically involved. Some more specific commercially suitable portion sizes within bag 12 are respectively about 8.0, 12.0, 24.0 and 30.0 ounces. For a 12.0 ounce portion size, liquid 22A has a weight somewhere in the range of about 1.0 to 3.0 ounces, and more typically about 1.5 to 2.0 ounces. More generally, of the total weight of assembly 16, liquid 22A makes up about 8.0 to 25.0%, more typically about 10.0 to 20.0%, and even more typically about 12.0 to 16.0%.

Food bag 12 may come in a variety of shapes, although it is preferred that the bag have an outer perimeter 24 having substantially straight opposed sides 26A and B and opposed ends 28A and B. Bag 12 has a front 30 and an opposed rear 32 with window 14 disposed along front 30. Any bag suitable to the process may be used. A preferred bag for the present method is described in U.S. Pat. No. 6,033,114 granted to Grimm et al., which was discussed in the Background section of the present application and the contents of which are incorporated herein by reference. Bag 12 is freezable, ovenable and microwavable.

With reference to FIG. 2, a freezing container or “pop out” tray 34 is provided for freezing the food items to make up frozen food assembly 16. Tray 34 has a substantially flat bottom wall 36, a pair of opposed substantially flat side walls 38A and 38B and a pair of opposed substantially flat end walls 40A and 40B defining therewithin a rectangular freezing cavity 42. Cavity 42 serves as a mold for producing a frozen molded form made up of frozen food assembly 16.

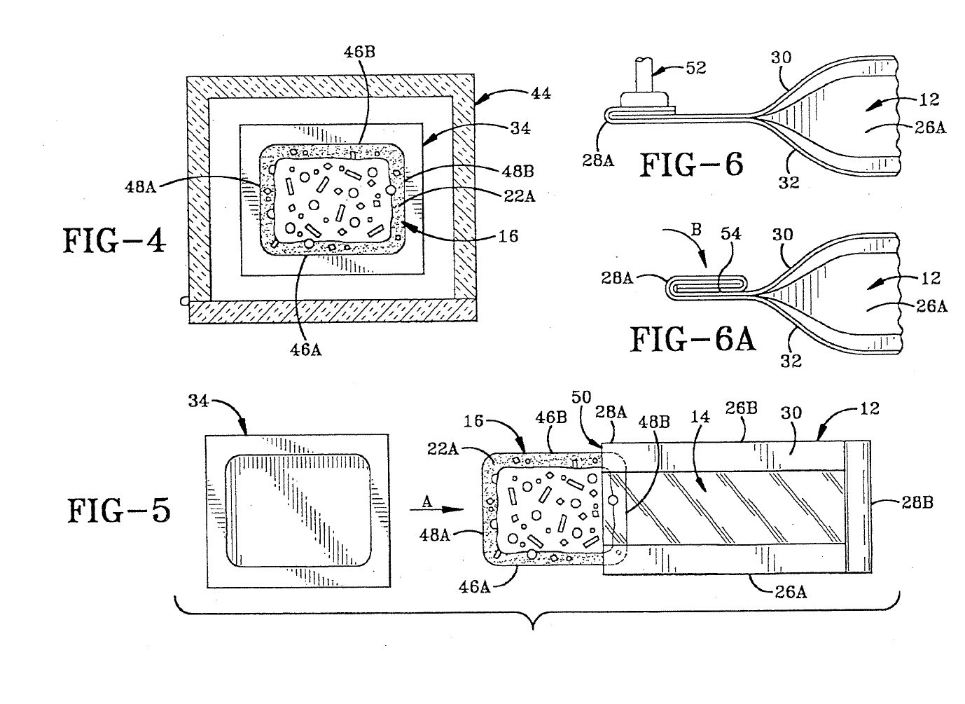

As shown in FIG. 3, meat, poultry or seafood proteins 18, pieces 20 and liquid 22B which will be frozen to become frozen liquid 22A is placed in cavity 42 of tray 34. At this point, meat 18 and pieces 20 are preferably uncooked and as fresh as possible, although they may also be provided as being fully or partially cooked. Liquid 22B most preferably completely covers bottom wall 36 and extends upwardly therefrom some distance alongside walls 38 and end walls 40. Tray 34 with its contents is then placed in a freezer 44 (FIG. 4) in order to freeze food assembly 16 so that it becomes a frozen molded form having the shape of cavity 42 of tray 34 except for the upper surface which remains in whatever form the various parts of the food are disposed. Food assembly 16 is thus a substantially rectangular frozen slab having a rear which is flat and an outer perimeter having straight flat opposed sides 46A and B and straight flat opposed ends 48A and 48B. These flat outer surfaces are formed primarily of frozen liquid 22A except for any pieces of the food which contacted the various walls of tray 34 during the process of producing the frozen form. Preferably, the shape of the frozen molded form when inserted in bag 12 helps align the main part of assembly 16, such as meat 18, with window 14 for desirable display.

Once frozen, in one embodiment, the food assembly 16 is removed from tray 34 as shown in FIG. 5 and inserted as indicated at Arrow A into the interior of bag 12 via an entrance opening 50 at end 28A. As noted above, the formation of assembly 16 as a block or unit is helpful in its handling. With meat 18 and pieces 20 embedded in frozen liquid 22A, assembly 16 may be easily popped out of cavity 42 of tray 34 as a unit without, or substantially without, losing any of the components making up assembly 16. Likewise, frozen assembly 16 is easily handled manually or by machine for insertion into bag 12 without such a loss.

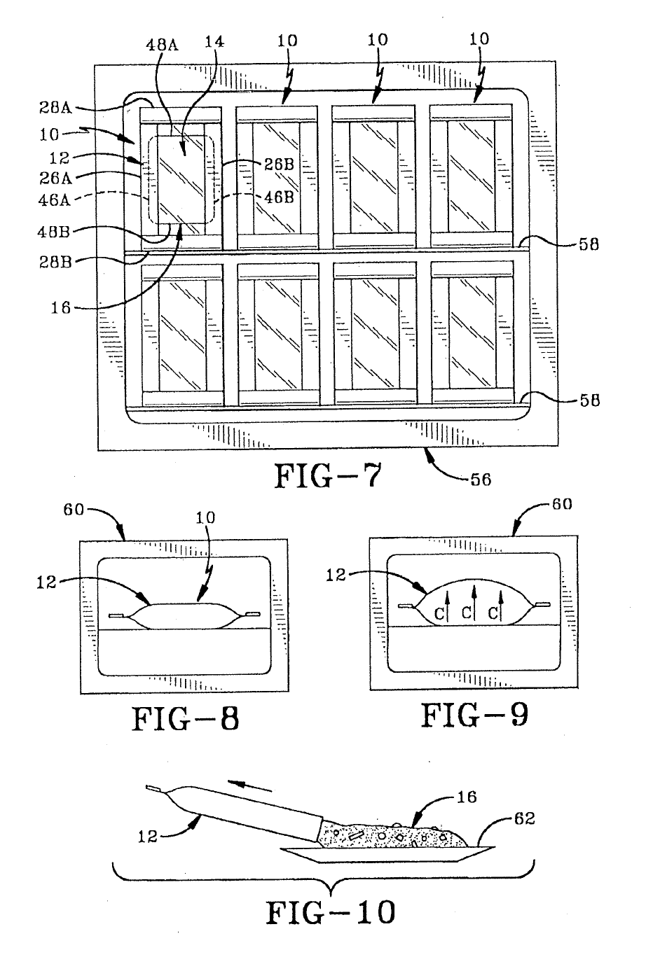

Once food assembly 16 is fully inserted, bag 12 is sealed adjacent end 28A thereof as shown in FIGS. 6 and 6A. More particularly, FIG. 6 shows bag 12 adjacent end 28A being heat sealed by a suitable heat sealing device 52. Preferably, end 28A is then folded over as indicated at Arrow B in FIG. 6A and sealed with an adhesive 54 to further secure the bag in a closed position. The heat sealing of bag 12 provides a sealed environment for containing food assembly 16 in the frozen and liquid states.

Once food assembly 16 is frozen and sealed within bag 12, it is ready for shipping while frozen to stores or other commercial establishments, where it may be displayed in a freezer section 56 as shown in FIG. 7. Packages 10 may be displayed as desired, but are preferably either laid on their rear surfaces or stood upright on one of sides 26 or ends 28 on a shelf 58. Display window 14 allows customers to see the fresh ingredients inside bag 12 to make the product more appealing. In addition, bags 12 may be individually or singly boxed in so-called inner boxes to individually protect bag 12 and its contents, and the inner boxes packed in a larger outer box or container for shipping. Thus, for instance, pictures or images of food assembly 16 in a cooked and/or uncooked state may be applied to the inner boxes instead of displaying bags 12 in an exposed manner which could lead to bags 12 being damaged.

The integrity of the frozen unit of assembly 16 is fully, or substantially fully, maintained throughout the handling and shipping processes, including handling by the consumer. This ability for assembly 16 to remain substantially in its original form is a significant benefit during these various processes and results in delivery of a product which is appealing to the consumer without product loss. Once purchased, the consumer is able to place package 10 while still frozen directly into a standard or microwave oven 60 as shown in FIG. 8 and cook food assembly 16 within bag 12, which expands as indicated at Arrows C in FIG. 9 as steam is generated therewithin.

The steam and a degree of pressure which builds up within bag 12 facilitates the cooking of food assembly 16 while bag 12 retains the liquids therewithin during the cooking process. More particularly, bag 12 remains sealed during the cooking process and holds in the steam so that the inside of bag 12 becomes saturated with steam. In further detail, frozen liquid 22A when heated in the cooking process melts and vaporizes before the other components in bag 12 due to its lower, more water-like viscosity. These other components include any sauce in bag 12, meat 18 and pieces 20. Typically, liquid 22A is completely vaporized while meat 18, pieces 20 and any sauce in bag 12 remain frozen or substantially frozen. In a relatively short period, bag 12 becomes completely saturated with the hot water vapor. The water vapor in bag 12 typically reaches a temperature of about 217-218° F. and condenses on the frozen food.

This condensation process provides substantial heat transfer to and penetration into the food and thus accelerates the cooking process while simultaneously allowing moisture within the food to be retained therein, in other words preventing dehydration of the food. More particularly, the steam derived from liquid 22A prevents or substantially prevents the intra-molecular water within the food from creating steam which would cause product dehydration. For the typical meal-sized contents of bag 12, the melted liquid originating from frozen liquid 22A typically vaporizes sometime during the first one or two minutes of cooking although this may vary.

The relatively early vaporization of liquid 22 is a key in preventing sauces within bag 12 from burning. Simply adding more sauce, which is usually much more viscous than liquid 22, normally will not provide the vaporization needed without the use of liquid 22. The typical sugar content of such sauces makes them quite susceptible to various chemical reactions such as caramelizing without the use of liquid 22. The vaporization of liquid 22 thus prevents the reduction or dehydration of the sauce and the increase in its viscosity that would occur as a result. This process also prevents the sauce from boiling, from caramelizing or from undergoing chemical reactions such as a Maillard reaction. In short, the present process allows moisture within the food items of assembly 16 to remain in the food items to produce a meal which is substantially more moist than that produced by known prior art methods.

Once cooked, package 10 is removed from oven 60, bag 12 is opened and food assembly 16 is removed from bag 12 as indicated in FIG. 10 onto a platter 62 or the like. Alternately, window 14 may be cut open and the meal eaten directly from the bag if desired while retaining the liquids therein. Bag 12 is also conveniently removable from oven 60 after cooking without the user getting burned. More particularly, the folded ends 28 of bag 12 are only minimally heated during cooking and thus serve as relatively cool handles which may typically be grasped directly for removal of bag 12 while avoiding such a burn risk.

Thus, package 10 and the method of producing and using the same provides a very convenient way of obtaining a very healthy and nutritionally balanced meal for the consumer. In addition, the use of fresh uncooked ingredients which are immediately frozen and stored in bag 12 provides a product which when cooked as described is a substantial improvement over the prior art methods of reheating food that has already been cooked. The retention of steam within bag 12 minimizes moisture loss from the food to keep the meal quite moist, especially in contrast to packages that are opened during the cooking process. This method also allows the production of a meal having a high quality taste without the necessity of providing preformed sauces, as previously noted. However, such sauces are often used, and the method advantageously prevents them from dehydrating, burning and so forth. In addition, this method is effective without the use of chemical preservatives.

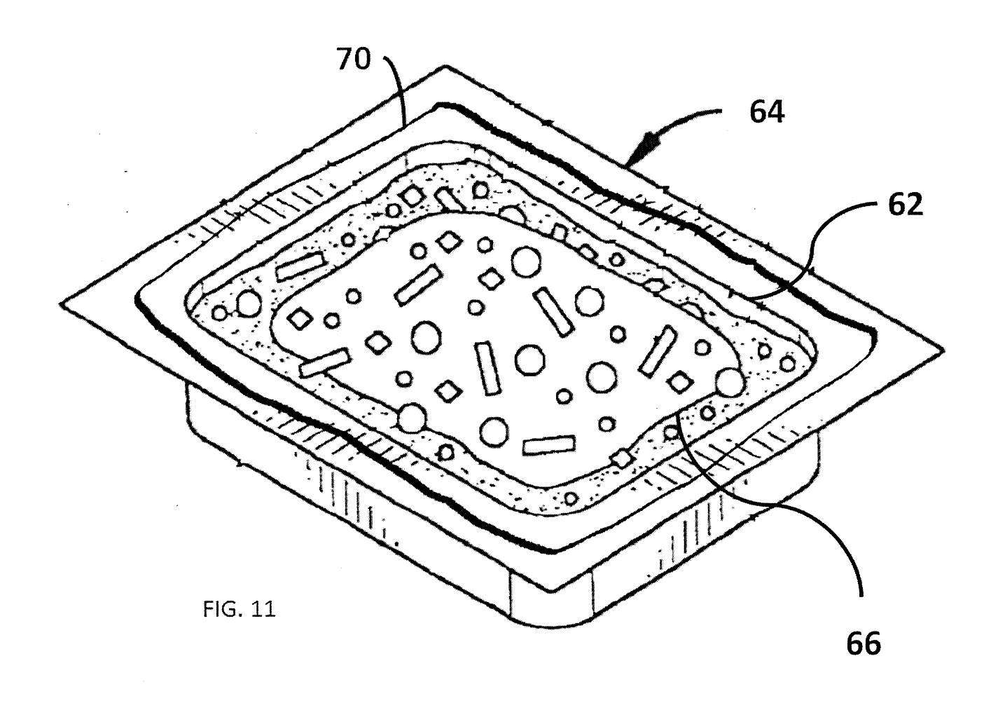

In one embodiment, a food package may comprise a food tray with a heat staked lidding film. Turning to FIG. 11, a food tray 64 may comprise a cavity 62 capable of holding a food assembly 66. Food assembly 66 may comprise frozen fresh, uncooked, cooked or partially cooked ingredients or food product. The tray 64 may be covered and sealed with a heat staked lidding film 70, which may cover, or substantially cover, the cavity 62. The lidding film 70 may be heat staked to the tray 64 using high heat and/or pressure. The lidding film 70 may be heat staked to the tray 64 prior to the food assembly 66 being frozen in the tray 64. Alternatively, the lidding film 70 may be heat staked to the tray 64 after the food assembly 66 is frozen in the tray 64. The heat staked lidding film 70 may be attached and/or sealed to the tray 64 via one or more sealants applied to the tray 64 and/or lidding film 70. The heat staked lidding film 70 may be heat sealed to the tray 64 by any suitable heat sealing device. The heat sealing of the tray 64 provides a sealed environment for containing food assembly 66 in frozen and/or liquid states. When the food package is heated, there may be no expansion of the heat staked lidding film 70.

In an embodiment, the lidding film 70 may comprise one or more layers. The layers of the lidding film 70 may comprise a layer that can be configured to brown and/or crisp the food product. The lidding film 70 may cover or substantially cover the tray cavity 62. In another embodiment, the lidding film 70 may cover or substantially cover the entire top surface area of the tray 64. Optionally, the heat staked lidding film 70 covers the entire cavity 62 of the tray and at least a portion of the top surface of the tray 64. In another embodiment, the heat staked lidding film 70 may cover the entire cavity 62 of the tray and extend over the edge of the tray 64.

The heat staked lidding film 70 may be microwavable and/or (convection) ovenable, may contain an anti-fogging coating, may be peelable and/or resealable, and/or may withstand a range of temperatures. The lidding film 70 may be transparent such that the food assembly 66 is visible through the lidding film 70. The lidding film 70 may also be printed with images, e.g., logos. In this way, a brand and/or contents of the package can be known to a consumer. The lidding film 70 may contain one or more tabs (not shown) suitable for heating and/or freezing, which tabs may be minimally heated during cooking and may help a user to remove the lidding film 70 from the tray. The tabs may also serve as relatively cool handles which may be grasped directly by a user for removal of the tray 64 which can help a user avoid the risk of a burn. The heat staked lidding film 70 and the tray 64 may be impermeable to liquids.

The heat staked lidding film 70 may optionally be configured to substantially cover the cavity 62 of the tray 64. The lidding film 70 may be configured such that it leaves space between the top surface of the food assembly 66 and the bottom surface, e.g., interior surface, of the lidding film 70. When the tray 64 is heated, the interior surface of the lidding film 70 may become saturated with hot water vapor as liquid vaporizes while meat and/or pieces of the food assembly 66 and/or any sauces in the tray 64 may remain frozen or substantially frozen. The water vapor in the tray may reach a temperature of about 217-218° F. and may condense onto the frozen meat and/or food pieces and/or sauces.

In an embodiment, the condensation process and/or steam-cooking when the tray 64 is heated may allow for accelerated cooking of the food product while preventing dehydration of food and/or sauces from undergoing chemical reactions, for example a Maillard reaction. In one embodiment, the food assembly 66 may be heated while it resides within the tray 64 and is enclosed within a bag. Alternatively, the tray 64 may be removed from the bag prior to cooking, for example in a microwave or convection oven. The heat staked lidding film 70 may comprise suitable materials for allowing for proper cooking of the food product, for example, the interior surface may comprise BPA-free Mylar film.

In another embodiment, a frozen food package, for example including the food assembly 66, the tray 64, and the lidding film 70, may be inserted into a secondary container (not shown). The secondary container may be, for example (without limitation), a cardboard box, bag or other suitable enclosures made of suitable material(s). The secondary container may be stackable and/or displayed, for example, on a shelf. The frozen food package may be removed from the secondary container and placed into a microwave and/or convection oven for heating and/or reheating of the food product. Alternatively, the second packaging tray may be retained within the secondary container during cooking and/or heating of the food product.

In an alternative embodiment, a food package may comprise a vacuum wrapped food tray. A food tray may comprise a cavity capable of holding a food assembly comprising frozen fresh, uncooked, cooked or partially cooked ingredients or food product. The tray may be covered and vacuum wrapped. The vacuum wrapping may cover, or substantially cover, the food assembly. The vacuum wrapping may also utilize shrink film, for example, to have a tight fit to the food assembly contents. The vacuum wrapping may be heat sealed to the tray. The vacuum wrapping may be sealed to the tray prior to the food assembly being frozen in the tray. Alternatively, the vacuum wrapping may be sealed to the tray after the food assembly is frozen in the tray 64. The vacuum wrapping may be sealed to the tray by any suitable vacuum wrapping/packing device. The vacuum wrapping of the tray provides a sealed environment for containing food assembly in frozen and/or liquid states. When the food package is heated, there may be expansion of the vacuum wrapping.

Both the food package with the heat staked lidding film 70 and the food package with a vacuum wrapped food tray remain sealed during the cooking process and holds in the steam so that the inside of food package becomes saturated with steam. The frozen liquid, when heated, melts and vaporizes before the other components (e.g., meat, pieces, and sauces) in the food package due to its lower, more water-like viscosity. In a relatively short period, the food package becomes completely saturated with the hot water vapor and the water vapor condenses on the frozen food. This condensation process provides substantial heat transfer to and penetration into the food and thus accelerates the cooking process while simultaneously allowing moisture within the food to be retained therein, in other words preventing dehydration of the food. More particularly, the steam derived from liquid prevents or substantially prevents the intra-molecular water within the food from creating steam which would cause product dehydration.

A user may consume the heated frozen food assembly directly from the food package once the lidding film or vacuum wrapping is removed or substantially removed from the tray. The food product within the cavity of the tray may be directly accessible to a user. Alternatively, at least a portion of the lidding film or vacuum wrapping may be removed, detached, and/or peeled away from the tray and the heated food product may be moved to a plate, bowl, and/or similar food serving mechanism.

In the foregoing description, certain terms have been used for brevity, clearness, and understanding. No unnecessary limitations are to be implied therefrom beyond the requirement of the prior art because such terms are used for descriptive purposes and are intended to be broadly construed.

While the present disclosure has been discussed in terms of certain embodiments, it should be appreciated that the present disclosure is not so limited. The embodiments are explained herein by way of example, and there are numerous modifications, variations and other embodiments that may be employed that would still be within the scope of the present disclosure.

1. A method of making a food package comprising a frozen molded food form contained in a sealed tray, said method comprising:
providing a tray having a cavity;
placing liquid and food in the cavity;
placing the tray in a freezer, wherein the liquid and food freeze to form a frozen molded food form in the cavity; and
removing the tray from the freezer,
wherein the tray is sealed with a heat staked film prior to placing the tray in the freezer or after removing the tray from the freezer.

2. The method of claim 1, wherein the step of placing liquid and food in the cavity further comprises providing liquid that covers at least a portion of a bottom wall of the cavity and extends therefrom along one or more walls of the cavity, wherein after freezing, the frozen liquid surrounds the food, along a perimeter of the frozen molded food form.

3. The method of claim 1, wherein the step of placing liquid and food in the cavity further comprises placing cooked or partially cooked food in the cavity.

4. The method of claim 2, wherein the step of placing liquid and food in the cavity further comprises placing cooked or partially cooked food in the cavity.

5. The method of claim 1, wherein step of placing liquid and food in the cavity further comprises embedding the food within the liquid.

6. The method of claim 1, wherein the heat staked film is impermeable to liquid.

7. The method of claim 1, wherein the step of placing liquid and food in the cavity comprises providing that the liquid comprises at least 8.0% of the frozen molded food form, by weight.

8. The method of claim 1, wherein the step of placing liquid and food in the cavity comprises providing that the frozen molded food form comprises at least 90.0% water by weight.

9. The method of claim 1, wherein the step of placing liquid and food in the cavity further comprises:
placing liquid along a bottom wall of the cavity;
placing food at a location substantially central to the cavity; and
moving food from the location substantially central to the cavity towards a perimeter of the cavity.

10. The method of claim 9, wherein moving food from the location substantially central to the cavity towards a perimeter of the cavity forms a ring of liquid around the food.

11. The method of claim 10, wherein the ring of liquid is configured to vaporize and condense onto a surface of the food when heated.

12. The method of claim 1, wherein the step of placing liquid and food in the cavity comprises providing that the frozen molded food form comprises frozen sauce having a viscosity at 150 degree F. in the range of 1,000 to 8,000 cPs.

13. The method of claim 1, wherein the step of placing liquid and food in the cavity comprises providing that the frozen molded food form comprises frozen sauce having a viscosity at 150 degree F. in the range of 1,000 to 8,000 cPs, further comprising providing that the frozen sauce is configured such that the frozen sauce does not caramelize during cooking of the uncooked food.

14. The method of claim 1, wherein the step of placing liquid and food in the cavity comprises providing that the frozen molded food form comprises frozen sauce having a viscosity at 150 degree F. in the range of 1,000 to 8,000 cPs, further comprising providing that the frozen sauce is configured such that the frozen sauce does not undergo a Maillard reaction during cooking of the uncooked food.

15. The method of claim 1, wherein the step of placing liquid and food in the cavity comprises placing at least a portion of the liquid substantially on top of the food.

16. The method of claim. 1, wherein the tray is at least one of ovenable and microwavable.

17. The method of claim 1, wherein the tray is placed in a secondary container.

18. The method of claim 1, wherein the heat staked film does not expand when heated.

19. The method of claim 1, wherein steam is generated from the frozen liquid when heated during cooking, and wherein moisture in the frozen food is retained within the frozen food during heating.

20. A method of making a food package comprising a frozen molded food form contained in a sealed tray, said method comprising:
providing a tray having a cavity;
placing liquid and food in the cavity;
placing the tray in a freezer, wherein the liquid and food freeze to form a frozen molded food form in the cavity; and
removing the tray from the freezer,
wherein the tray is vacuum wrapped prior to placing the tray in the freezer or after removing the tray from the freezer.
